(19) United States
(12) Patent Application Publication
(10) Pub. No.: US 2023/0295892 A1
(43) Pub. Date: Sep. 21, 2023

(54) OFFSHORE SUBSTRUCTURE SUPPORTED BY TEMPLATE-INTEGRATED SUCTION FOUNDATION AND INSTALLATION METHOD THEREOF

(71) Applicant: K-BETS, Mokpo-si Jeollanam-do (KR)

(72) Inventors: Ha-yoon ZI, Seoul (KR); Seung-yun CHO, Seoul (KR)

(21) Appl. No.: 18/009,376

(22) PCT Filed: Dec. 3, 2021
(86) PCT No.: PCT/KR2021/018182

§ 371 Date: Dec. 9, 2022

(30) Foreign Application Priority Data
Nov. 30, 2021 (KR) 10-2021-0168901

(51) Int. Cl. E02D 27/52; E02D 29/09; E02D 7/20

(52) U.S. Cl. CPC E02D 27/525; E02D 29/06; E02D 7/20; E02B 17/00

(57) ABSTRACT

The present disclosure relates to an offshore substructure supported by a template-integrated suction foundation and an installation method thereof, more particularly to an offshore substructure installed by pre-piling construction including: a suction foundation having a plurality of suction piles pre-inserted into the seabed by suction, joint sockets connected to each head part of the suction piles, and connecting members connecting spaces between the joint sockets; and a substructure connected onto an upper part of a suction foundation pre-piled, wherein an insertion socket connected to a lower part of the substructure is inserted into the joint socket, and the suction foundation and the substructure are connected by grouting a space between the insertion socket and the joint socket.

### BACKGROUND

### Technical Field

The present disclosure relates to an offshore substructure supported by a template-integrated suction foundation and an installation method thereof. Particularly, the present disclosure relates to a support structure for an offshore plant and an offshore wind power facility, which is installed into a form of suction pile foundation on soft ground such as sand and mud, etc. and an installation method thereof.

### RELATED ART

A structure installed on the sea is composed of a substructure installed on the seabed and a foundation structure inserted under the seabed and securing supporting forces.

(A) The substructure includes various forms, such as a jacket structure, a tripod and a monopole, etc., depending on the shape thereof. (B) The foundation structure is classified into a pile, a direct foundation and a suction foundation, etc.

A combination of the jacket structure and the pile has been being used in the field of offshore oil drilling industry for a long period of time, and thus the usefulness thereof is appreciated widely.

In a case of installing and operating a single or a few large-scale jackets, a method of construction popularly known as “post-piling construction” is used, in which a pile is installed on the ground by mounting a jacket structure on the seabed and then a pile is inserted inside a leg of the jacket structure. However, when installing multiple structures such like an offshore wind power complex, the installation process of the post-piling construction is affected largely by oceanic circumstances.

When necessary to build a large-scale offshore complex, in order to reduce the cost and duration of construction, “pre-piling construction” is used, in which piles are pre-installed at regular intervals and heights, at installation positions on the seabed, and then a support structure is combined with head parts of corresponding piles to form a final structure. Currently as of the year 2021, this construction method has been widely used in Europe and Taiwan, etc. and is considered as a leading candidate applicable for west-south offshore complex in Korea.

FIG. 1 to FIG. 4 are cross-sectional views, each showing a pre-installation process of a foundation structure using a template(s) in the prior art pre-piling construction. FIG. 5 and FIG. 6 are cross-sectional views, each showing a connection process of a substructure to the inside of a pre-piled pile.

As shown in FIG. 1, a template 3 is conveyed and installed on the seabed 1 for insertion of a pile 4. As shown in FIG. 2 and FIG. 3, the pile 4 is inserted inside a pile insertion guide portion of the template 3. As shown in FIG. 4, the template 3 is removed, followed by constructing a pre-pile. As shown in FIG. 5 and FIG. 6, a substructure 10 is conveyed, a joint of a jacket leg 11 of the substructure 10 is inserted inside an insertion portion of the insertion pile 4, and then an in-between space thereof is underwent to grouting 30 for connection.

In applying pre-piling construction successfully, in order to construct a plurality of the piles 4 forming a foundation that supports a single type of the substructure 10, at correct positions with a minimum error, it is necessary to use the template 3 of which an installation position between the piles 4 is pre-set. In order to minimize the error between the piles 4, the inside of the template 3 forms such an underwater robot into which various sensors and hydraulic devices are integrated as one body and which is an expensive device. Also, a special ship is necessary to operate the template 3.

It is very significant to control the error between the piles 4 on a plane, as shown in FIG. 8, as well as perpendicular heights of the piles 4. In the pre-piling construction, the pile 4 and the jacket leg 11 of the substructure 10 are connected by using grout 30 in a space therebetween. Thus, in order to maximize jointability of a grouted connection, studs 6 should be arranged regularly at regular intervals on a joint surface of the substructure 10 connected to either the inside or the outside of the pile 4. Preferably, as shown in the left hand side of FIG. 7, a stud of the pile and a stud of the substructure should be arranged with a stagger with each other and then joined by grouting. Since installation of the studs on either the substructure or a surface of the pile is made up at a plant, an error occurred is minor. However, due to a perpendicular error inevitably occurred during mutual joint thereof at a work site, occurrence of an undesired error in the joint is not avoidable, as shown in the right-hand side of FIG. 7.

Further, when applying prior art construction and installation methods, an error in construction is occurred due to an interval of the template 3 and the pile 4, and there is also a problem in obtaining an accurate position due to the error in the mutual position between the template 3 and the pile 4. The right hand side of FIG. 7 is a cross-sectional view showing a state that a height of a stud in an insertion portion of a prior art insertion pile is not equal to that of a stud in the joint of the jacket leg. FIG. 8 is a plane view showing a state that a joint of a prior art jacket leg is not placed in the middle of an insertion portion of the insertion pile.

Further, it is necessary to develop a gripper which calibrates a gradient of the structure after the connection and fixes the joint until the grouted connection is hardened.

This pre-piling construction can be used by combining various structure types, such as a jacket structure and a tripod, etc.

In order to overcome problems which the pre-piled structure has, a structure in which a substructure and a suction foundation are integrated as one body has been provided. FIG. 9 is a cross-sectional view showing a substructure having a prior art suction foundation. It is advantageous to expeditiously install the structure under a suitable ground condition. In order to apply this structure successfully, since the foundation is such a type that a direct foundation is basically inserted under the seabed, it is necessary to overcome all problems resulting from the direct foundation. In order to overcome these problems, a size of the suction foundation is increased.

As scaling up the suction foundation, it is difficult to make the suction foundation up after manufacturing in a state of being laid down. Thus, it is unavoidable to manufacture the suction foundation in a perpendicular manner. Since the substructure and the suction foundation are manufactured as one body, the height of the structure is inevitably increased. Thus, it is difficult to obtain a manufacturing site, and it is also necessary to scale up offshore devices for the transportation of the structure to the work site and for the loading and unloading thereof.

### SUMMARY

### Technical Problem

Therefore, the present disclosure is contrived to solve conventional problems as described above. According to the present disclosure, an offshore substructure supported by a template-integrated suction foundation aims: to avoid the use of a template pointed out in the pre-piling construction; to remove errors occurred when installing a foundation structure; to use, as a pre-installation foundation, suction foundations which are manufactured by fixing each other at a plant by combining the combination of the principal concept that a foundation structure and a substructure of the pre-piling construction are separately installed, with an advantage of a suction foundation; and to install the suction foundation; and then to assemble the substructure onto an upper portion of the suction foundation installed.

According to the present disclosure, the offshore substructure supported by a template-integrated suction foundation aims: to minimize weight thereof compared to when installing those structures at the same time due to separation installations of the foundation structure and the substructure, whereby, minimizing a fleet of ships composing offshore devices; to control an error occurred in the foundation structure to the level of an error occurred at a plant, due to installation of the suction foundations fixed to each other in advance, whereby minimizing the error and consequently allowing minimizing interference of a gripper used for joint fixation of the suction foundation and studs in-between a joint of the substructure; and to minimize the error in the joint, whereby easily applying internal and external grippers and needing to use no template.

Meanwhile, technical problems to be solved in the present disclosure are not limited to the aforementioned technical problems, and other technical problems, which are not mentioned above, will be apparently understood to a person having ordinary skill in the art from the following description.

### Technical Solution

The first aim of the present disclosure may be achieved by an offshore substructure supported by a template-integrated suction foundation, as an offshore substructure installed by pre-piling construction, including: a suction foundation having a plurality of suction piles pre-inserted into the seabed by suction, joint sockets connected to each head part of the suction piles, and connecting members connecting spaces between the joint sockets; and a substructure connected onto an upper part of a suction foundation pre-piled, wherein an insertion socket connected to a lower part of the substructure is inserted into the joint socket, and the suction foundation and the substructure are connected by grouting a space between the insertion socket and the joint socket.

Further, a plurality of studs are installed in an inner surface of the joint socket and outer surface of the insertion socket, respectively.

Further, the suction foundation is manufactured as one body and conveyed to a construction site, and then is inserted into a set position, a position and a height of the suction pile are controlled through a suction unit, an upper flange provided to an upper part of the joint socket, and a lower flange provided between a substructure body and the insertion socket are included, the upper flange and the lower flange are in contact with each other during installation, and a gripper unit fixing a space between the insertion socket and the joint socket is included so as to prevent relative displacements of the substructure and the suction foundation until grout is hardened.

The second aim of the present disclosure may be achieved by an installation method of an offshore substructure supported by a template-integrated suction foundation, as a method of installing an offshore substructure installed by pre-piling construction, comprising steps of: manufacturing a suction foundation having a plurality of suction piles, joint sockets connected to each head part of the suction piles, and connecting members connecting spaces between the joint sockets; after seating the suction foundation on the seabed where to be constructed, installing the suction foundation by inserting the suction pile into a position where to be constructed of the seabed; inserting an insertion socket to be installed to a lower part of a substructure, inside the joint socket; and connecting the insertion socket and the joint socket by grouting a space therebetween.

Further, a gripper unit fixes a space between the insertion socket and the joint socket so as to prevent relative displacements of a substructure and the suction foundation until grout is hardened.

### Advantageous Effects

According to an offshore substructure supported by a template-integrated suction foundation and an installation method thereof in accordance with the present disclosure, it is advantageously capable of: avoiding the use of a template pointed out in the pre-piling construction; removing errors occurred when installing a foundation structure; using, as a pre-installation foundation, suction foundations which are manufactured by fixing each other at a plant by combining the combination of the principal concept that a foundation structure and a substructure of the pre-piling construction are separately installed, with an advantage of a suction foundation; and installing the suction foundation; and then assembling the substructure onto an upper portion of the suction foundation installed.

Further, according to an offshore substructure supported by a template-integrated suction foundation and an installation method thereof in accordance with the present disclosure, it is advantageously capable of: minimizing weight thereof compared to when installing those structures at the same time due to separation installations of the foundation structure and the substructure, whereby, minimizing a fleet of ships composing offshore devices; controlling an error occurred in the foundation structure to the level of an error occurred at a plant, due to installation of the suction foundations fixed to each other in advance, whereby minimizing the error and consequently allowing minimizing interference of a gripper used for joint fixation of the suction foundation and studs in-between a joint of the substructure; and minimizing the error in the joint, whereby easily applying internal and external grippers and needing to use no template.

Meanwhile, advantageous effects to be obtained in the present disclosure are not limited to the aforementioned effects, and other effects, which are not mentioned above, will be apparently understood to a person having ordinary skill in the art from the following description.

### BRIEF DESCRIPTION OF THE DRAWINGS

The accompanying drawings of this specification exemplify a preferred embodiment of the present disclosure, the spirit of the present disclosure will be more clearly understood from the following detailed description taken in conjunction with the accompanying drawings, and thus it will be understood that the present disclosure is not limited to only contents illustrated in the accompanying drawings;

FIG. 1 to FIG. 4 are cross-sectional views each showing a pre-installation process of a foundation structure using a template(s) in the prior art pre-piling construction,

FIG. 5 and FIG. 6 cross-sectional views each showing a connection process of a substructure to the inside of a pre-piled pile,

FIG. 7 is a cross-sectional view showing a state that a height of a stud in an insertion portion of a prior art insertion pile is not equal to that of a stud in the joint of the jacket leg,

FIG. 8 is a plane view showing a state that a joint of a prior art jacket leg is not placed in the middle of an insertion portion of the insertion pile,

FIG. 9 is a cross-sectional view showing a substructure having a prior art suction foundation,

FIG. 10 to FIG. 12 are cross-sectional views each showing an installation process of an offshore substructure supported by a template-integrated suction foundation according to an embodiment of the present disclosure,

FIG. 13 is a plane view showing a suction foundation according to an embodiment of the present disclosure,

FIG. 14 is a flowchart showing an installation method of an offshore substructure supported by a template-integrated suction foundation according to an embodiment of the present disclosure,

FIG. 15 is a cross-sectional view showing a suction foundation pre-installed (left hand side) and a state that a substructure is connected to the suction foundation (right hand side), according to an embodiment of the present disclosure.

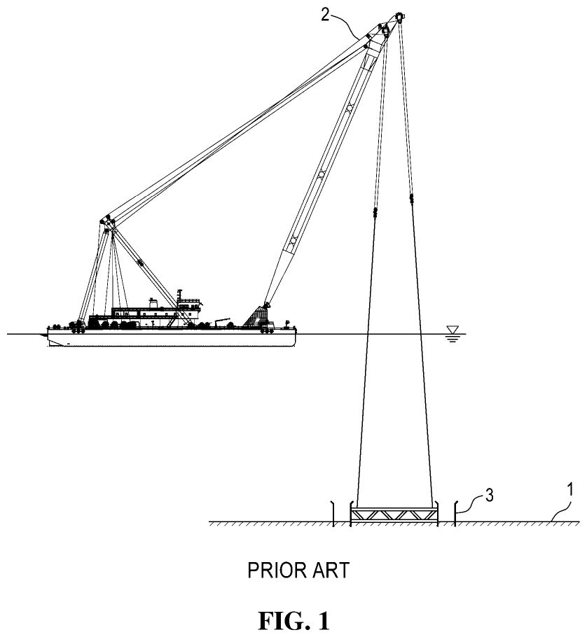

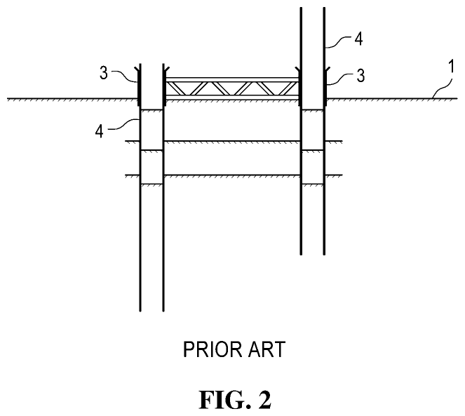

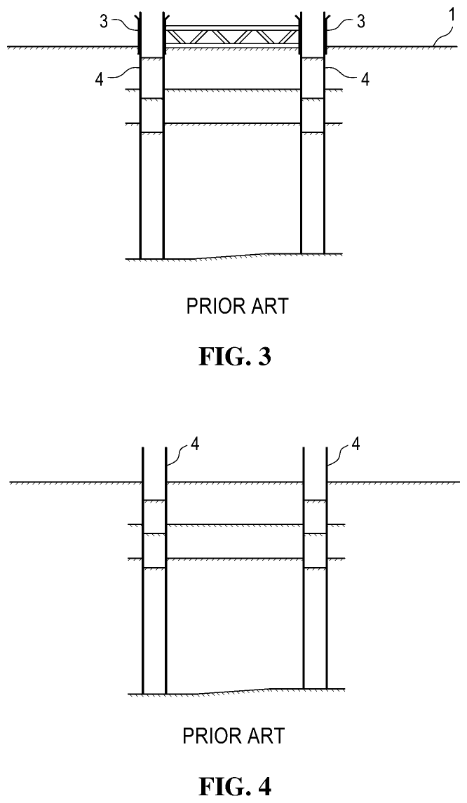

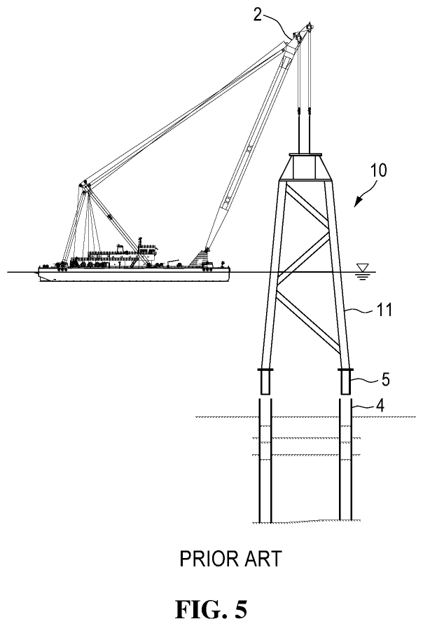

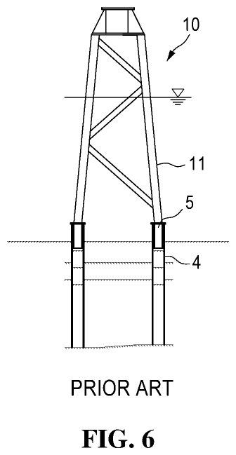

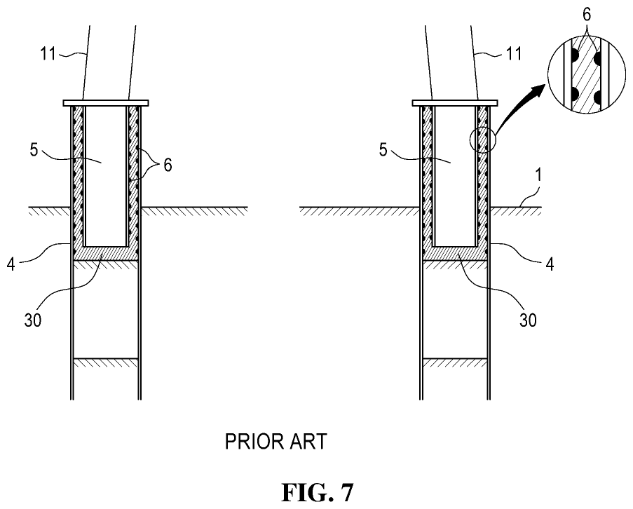

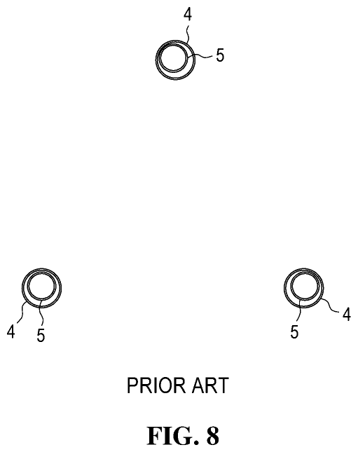

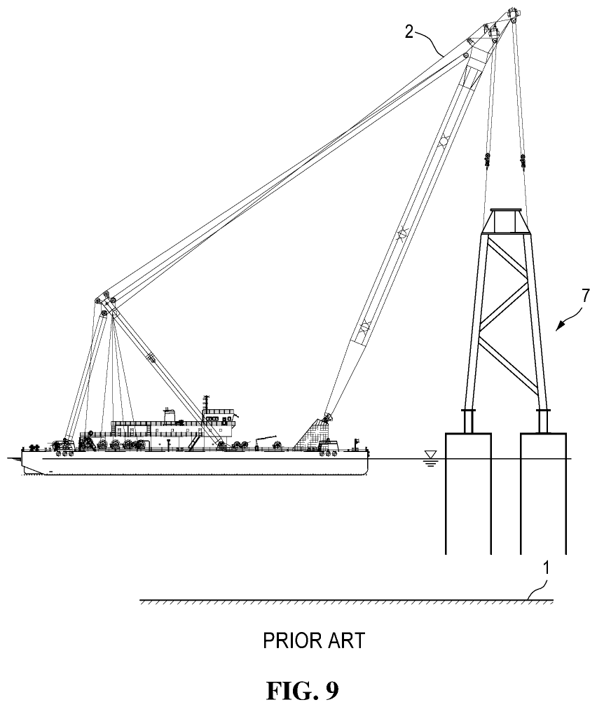

### FIGURE REFERENCE NUMBERS

1: seabed
2: crane
3: template
4: insertion pile
5: insertion portion
6: stud
7. suction pile-integrated substructure
10: substructure
11: jacket leg
12: body
13: insertion socket
14: jacket stud
15: lower flange
20: suction foundation
21: suction pile
22: joint socket
23: connecting member
24: suction foundation stud
25: upper flange
30: grout
100: offshore substructure supported by a template-integrated suction foundation

### DETAILED DESCRIPTION

### Best Mode

Hereinafter, described are configuration and functions of an offshore substructure supported by a template-integrated suction foundation according to an embodiment of the present disclosure, and an installation method thereof.

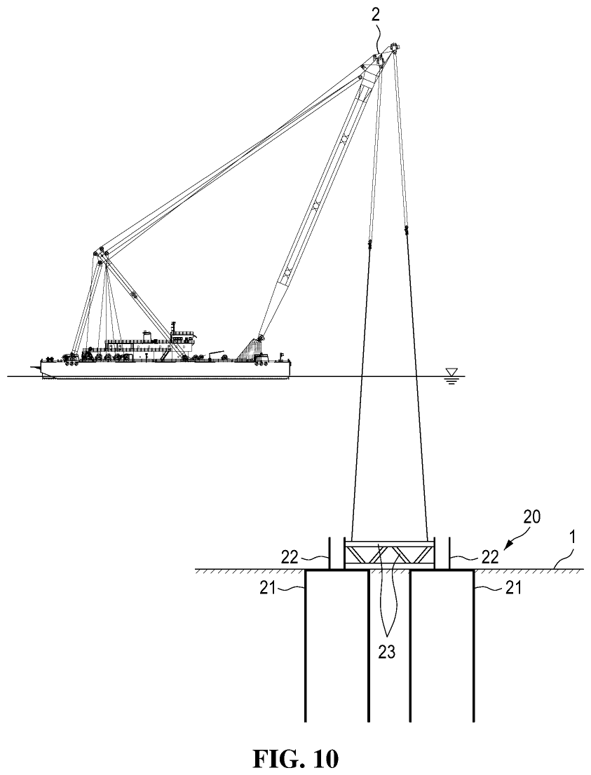

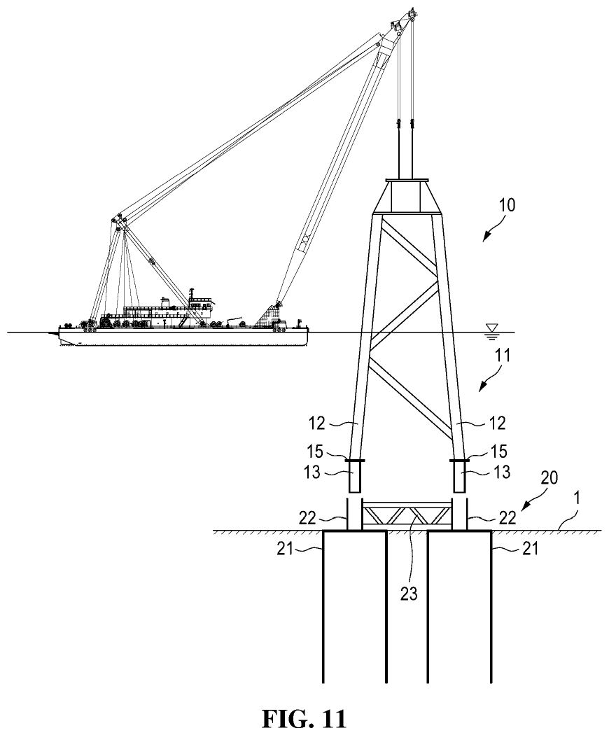

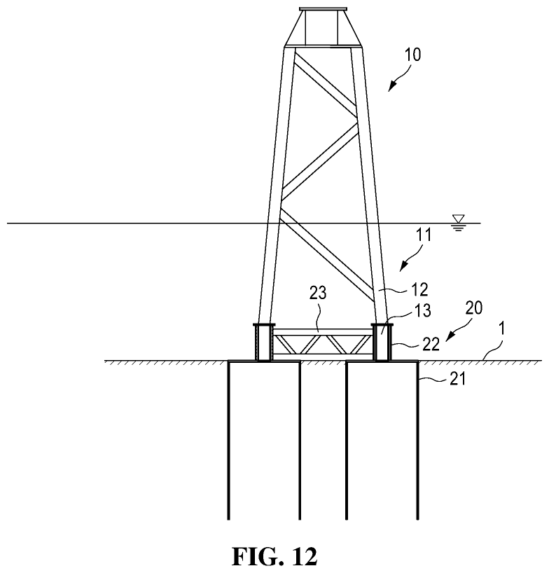

Firstly, FIG. 10 to FIG. 12 are cross-sectional views each showing an installation process of an offshore substructure supported by a template-integrated suction foundation according to an embodiment of the present disclosure.

As shown in FIG. 10, according to the present disclosure, it is seen that a suction foundation 20 is applied as a foundation of a pre-pile in advance. That is, the suction foundation is manufactured and conveyed to a construction site. Then, the suction foundation 20 is inserted into the seabed 1.

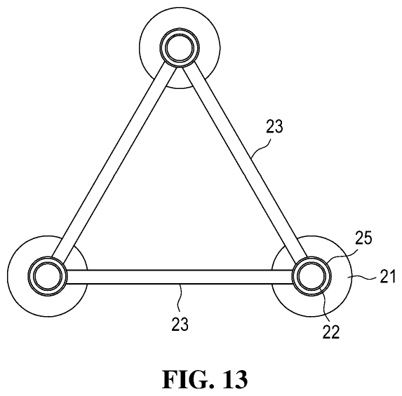

FIG. 13 is a plane view showing a suction foundation according to an embodiment of the present disclosure. It is seen that the suction foundation 20 according to the present disclosure has a plurality of suction piles 21 to be inserted to the seabed 1 by suction, joint sockets 22 connected to each head part of these suction piles 21, and a connecting members 23 made of a rigid material and connecting an in-between space of the joint sockets 22.

That is, a plurality of the suction piles (21) having a cylinder shape is manufactured on the basis of a design taking account of ground characteristics at an installation site. The plurality of the suction piles 21 is connected with the connecting member 23 securing rigidity enough to maintain mutual positions thereof.

The joint socket 22 where a substructure 10 should be connected is formed in a head part of the individual suction pile 21. A plurality of studs 24 is arranged inside this joint socket 22 according to the design procedure.

The suction foundation 20 is seated on the seabed 1, and then the suction pile 21 is inserted into the seabed 1 while controlling a suction unit (not illustrated) to adjust a positon of the suction foundation 20. Accordingly, as applying this suction foundation 20 to pre-piling construction, the suction pile 21 is accurately inserted at a set position without using a template 3. Whereby an error in heights of the studs 24 can be minimized and an error in a joint can be likewise minimized.

Further, a jacket leg 11 of the substructure 10 is connected to an upper part of the suction foundation 20 pre-piled. That is, an insertion socket 13 connected to a lower part of a body 12 of the jacket leg 11 is inserted into the joint socket 22, and the suction foundation 20 and the substructure 10 are connected by grouting a space between the insertion socket 13 and the joint socket 22.

As mentioned above, the suction foundation 20 is manufactured as one body and conveyed to a construction site, and is inserted at a position where to be installed. A position and a height of the suction pile 21 are controlled through the suction unit. Further, an upper flange 25 provided to an upper part of the joint socket 22 and a lower flange 15 provided between the body 12 of the jacket leg and the insertion socket 12 are included. These upper flange 25 and the lower flange 15 are in contact with each other during installation.

Further, a gripper unit (not illustrated) fixing a space between the insertion socket 13 and the joint socket 22 is included so as to prevent relative displacements of the substructure 10 and the suction foundation 20 until grout 30 is hardened.

That is, the substructure 10 is designed without any separate foundation structure. The insertion socket 13 connectable to the joint socket 22 installed to the head part of the suction pile 21 is installed in a lower part of this substructure 10. Also, in this insertion socket 13, a stud 14 is manufactured in advance to maximize jointability.

After pre-installing the suction foundation 20 at a position of the seabed where a foundation structure should be installed, the substructure 10 is inserted into and fixed to the upper part of the joint by grouting.

Further, a hydraulic device such as the gripper unit may be used for fixation in order to prevent relative displacement of the joint until the grout 30 is hardened. As mentioned above, as minimizing the error in the joint, it is easy to apply internal and external grippers, and it is allowable to solve all problems in position errors, obtaining an accurate position of the pile, and disagreement of the heights of the studs, without using the template 3.

### MODE FOR INVENTION

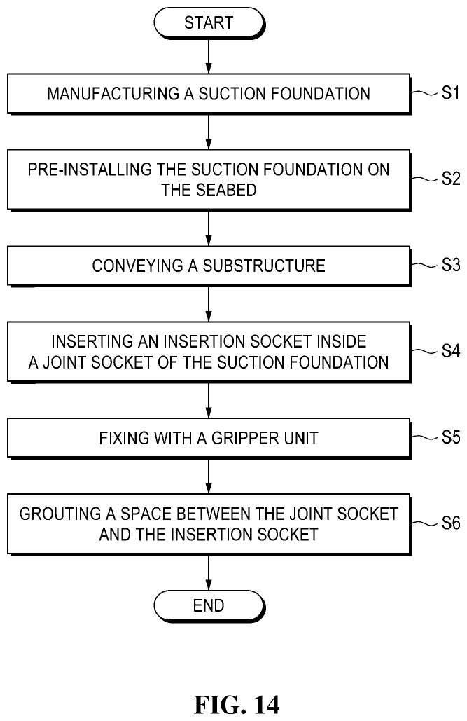

FIG. 14 is a flowchart showing an installation method of an offshore substructure supported by a template-integrated suction foundation according to an embodiment of the present disclosure. Firstly, manufactured is a suction foundation 20 having a plurality of suction piles 21, joint sockets 22 connected to each head part of the suction piles 21, and connecting members 23 connecting spaces between these joint sockets 22 S1.

After, seating the suction foundation 20 on the seabed 1 where to be constructed, the suction foundation 20 is installed by inserting the suction pile 21 into a position where to be constructed of the seabed 1 S2.

The substructure 10 is conveyed, and an insertion socket 13 installed to a lower part of a jacket leg 11 of the substructure 10 is inserted inside the joint socket 22 S4. A space between the insertion socket 13 and the joint socket 22 is fixed through a gripper unit in order to prevent relative displacements of the substructure 10 and the suction foundation 20 S5. The insertion socket 13 and the joint socket 22 are connected by grouting 30 a space therebetween S6.

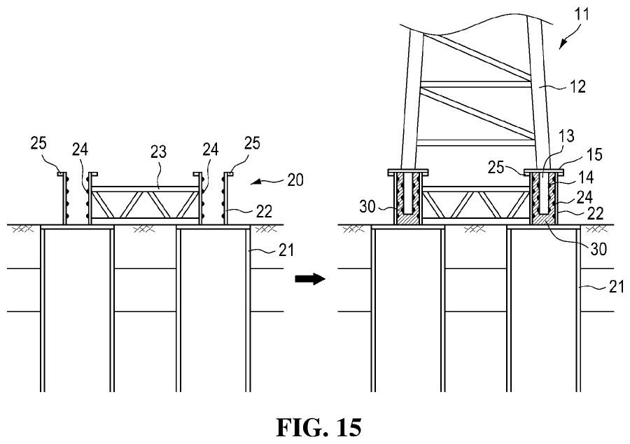

FIG. 15 is a cross-sectional view showing a suction foundation pre-installed (left hand side) and a state that a substructure is connected to the suction foundation (right hand side), according to an embodiment of the present disclosure.

As shown in FIG. 15, as applying the suction foundation 20 to pre-piling construction, the suction pile 21 is accurately inserted at a set position without using a template 3. Whereby an error in heights of the studs can be minimized and an error in a joint can be likewise minimized.

Further, as minimizing the error in the joint, it is easy to apply internal and external grippers, and it is allowable to solve all problems in position errors, obtaining an accurate position of the pile, and disagreement of the heights of the studs, without using the template.

1. An offshore substructure supported by a template-integrated suction foundation, as an offshore substructure installed by pre-piling construction, comprising:
a suction foundation having a plurality of suction piles pre-inserted into the seabed by suction, joint sockets connected to each head part of the suction piles, and connecting members connecting spaces between the joint sockets; and
a substructure connected onto an upper part of a suction foundation pre-piled, wherein
an insertion socket connected to a lower part of the substructure is inserted into the joint socket, and the suction foundation and the substructure are connected by grouting a space between the insertion socket and the joint socket.

2. The offshore substructure supported by a template-integrated suction foundation of claim 1, wherein
a plurality of studs are installed in an inner surface of the joint socket and outer surface of the insertion socket, respectively.

3. The offshore substructure supported by a template-integrated suction foundation of claim 2, wherein
the suction foundation is manufactured as one body and conveyed to a construction site, and then is inserted into a set position,
a position and a height of the suction pile are controlled through a suction unit,
an upper flange provided to an upper part of the joint socket, and a lower flange provided between a substructure body and the insertion socket are included,
the upper flange and the lower flange are in contact with each other during installation, and
a gripper unit fixing a space between the insertion socket and the joint socket is included so as to prevent relative displacements of the substructure and the suction foundation until grout is hardened.

4. An installation method of an offshore substructure supported by a template-integrated suction foundation, as a method of installing an offshore substructure installed by pre-piling construction, comprising steps of:
manufacturing a suction foundation having a plurality of suction piles, joint sockets connected to each head part of the suction piles, and connecting members connecting spaces between the joint sockets;
after seating the suction foundation on the seabed where to be constructed, installing the suction foundation by inserting the suction pile into a position where to be constructed of the seabed;
inserting an insertion socket to be installed to a lower part of a substructure, inside the joint socket; and
connecting the insertion socket and the joint socket by grouting a space therebetween.

5. The installation method of an offshore substructure supported by a template-integrated suction foundation of claim 4, wherein
a gripper unit fixes a space between the insertion socket and the joint socket so as to prevent relative displacements of a substructure and the suction foundation until grout is hardened.
